(19) United States
(12) Patent Application Publication
(10) Pub. No.: US 2011/0108599 A1
(43) Pub. Date: May 12, 2011

(54) FILM DISPENSER

(75) Inventors: Anthony Nottingham, Clayton (AU); Paul Maguire, Clayton (AU)

(73) Assignee: Multix Pty Ltd, Clayton (AU)

(21) Appl. No.: 12/616,909

(22) Filed: Nov. 12, 2009

(51) Int. Cl. B26D 1/00

(52) U.S. Cl. 225/77

(57) ABSTRACT

A film dispenser that includes a housing configured to receive and hold a roll of film. The housing has a dispensing opening through which a section of film can pass. The housing also has a lid that is movable between an open position where the dispensing opening is open and a closed position in which the dispensing opening is substantially closed. The lid has a film presentation member that is positioned to contact and hold a portion of the film when the lid is in the closed position and to present said portion of film within the dispensing opening for grasping when the lid is moved to the open position.

### CROSS-REFERENCE TO RELATED APPLICATIONS

This application claims priority from Australian Application No. 2009202941 filed on Jul. 21, 2009, the contents of which are to be taken as incorporated herein by this reference.

### FIELD OF THE INVENTION

The present invention generally relates to a film dispenser. The invention is particularly applicable for dispensing portions of cling film and it will be convenient to hereinafter disclose the invention in relation to that exemplary application. However, it is to be appreciated that the invention is not limited to that application and could be used as a dispenser for dispensing portions of various types of film or sheets of material such as cellophane, cling film, foil, grease proof paper, wrapping paper or the like.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge in Australia as at the priority date of the application.

Films for wrapping food are commonly sold packaged within a disposable cardboard dispensing box made to dispense the film during the lifetime of the roll of film. The dispensing box usually includes a dispensing opening through which the film is fed and at least one toothed blade positioned adjacent to or along one edge of the dispensing opening to allow the desired length of film to be cut from the roll of film.

The design of these boxes is generally basic, with the film being loosely retained within the box allowing the film on the roll to be unrolled and extended over the blade. This basic design is disadvantageous, because it allows the film to become wrapped around the roll and in relation to cling film, it can become very difficult to locate the free end of the film for film removal. With plastic cling film, the end of the film can also form folds and stick to the film on the roll.

It would therefore be desirable to provide a film dispenser which can present at least a portion of the film from the roll to a user each time the film dispenser is used.

### SUMMARY OF THE INVENTION

According to the present invention, there is provided a film dispenser that includes a housing configured to receive and hold a roll of film. The housing has a dispensing opening through which a section of film can pass. The housing also has a lid that is movable between an open position where the dispensing opening is open and a closed position in which the dispensing opening is substantially closed. The lid has a film presentation member that is positioned to contact and hold a portion of the film when the lid is in the closed position and to present said portion of film within the dispensing opening for grasping when the lid is moved to the open position.

The film dispenser according to the present invention provides a film presentation member that presents a portion of the film, preferably a portion at or proximate to an end or edge section of the film, for grasping by a user when the lid of the dispenser is moved to the open position. The film presentation member also preferably engages the portion of film within the dispenser thereby holding the film in place within the dispenser when the dispenser opening is closed.

In some instances, the film presentation member holds the film by adhesion. For some films, the film presentation member is able to adhere to a film material without additional adhesive assistance. For example, plastic wrap or another type of cling type film has a pressure sensitive adhesive property that can be utilised to releasably adhere the plastic wrap to the presentation member. However, other types of films such as baking paper, foil cellophane, grease proof paper, wrapping paper and the like have little or no self adhesive properties and will therefore generally require assistance to adhere to the presentation member. In some embodiments the film presentation member of the dispenser therefore includes an adhesive section for releasably adhering the portion of film thereto. The adhesive section provides a section of sticky or other releasably adherable substance to assist in adhering a portion of that film to the presentation member.

The adhesive section preferably includes a pressure sensitive adhesive, and more preferably a removable pressure sensitive adhesive so as to form a temporary bond to the portion of film. Pressure sensitive adhesives (PSAs) form a bond by the application of light pressure to marry the adhesive with the adhered. The bond forms because the adhesive is soft enough to flow (i.e. “wet”) the adherend. The bond has strength because the adhesive is hard enough to resist flow when stress is applied to the bond. In one embodiment, the adhesive section includes a section of double sided adhesive tape, preferably double sided pressure sensitive tape. This type of tape includes a pressure sensitive adhesive coated onto both sides of a backing material such as paper, plastic film, cloth, or metal foil.

The film presentation member can be located in any location where the film presentation member can contact and hold a portion of the film when the lid is in the closed position. The film presentation member can also present said portion of film for grasping when the lid is in the open position. In many embodiments this would generally locate the film presentation member within the dispensing opening. Preferably, the film presentation member extends away from the lid into the dispensing opening when the lid is in the open position, thereby presenting a portion of film at least a small distance away from the lid. More preferably, the film presentation member is configured to extend away from an inner surface of the lid and to extend at least partially in front of the roll of film when the lid is in the closed position. The film presentation member is therefore able to extend and contact a portion of film which extends between an edge of the dispensing opening and the roll of film when the lid is moved from the open position to the closed position. This advantageously can enable a free end of film to be presented for grasping adjacent to or in a part of the dispensing opening which is most readily accessible to a user of the dispenser.

The film presentation member can have any suitable configuration. In some embodiments, the film presentation member includes a flange or projecting member which projects away from an inner surface of the lid. Preferably, the projecting member includes at least one tab projecting away from an inner surface of the lid. The at least one tab can have any suitable configuration. However, it is preferable for the at least one tab to be an elongate tab running lengthwise substantially parallel a longitudinal edge of the housing that partly defines the dispensing opening. In some forms, the elongate tab is formed from at least two planar portions, a first planar portion connected to the lid and a second planar portion extending at an angle to the first planar portion in a direction generally away from the dispensing opening.

The dispenser can include a number of different lid configurations. In some embodiments, the lid is a separate section which is releasably attachable to the housing in which the roll of film is housed. In other embodiments, the lid is connected or otherwise attached to the housing in which the roll of film is housed. The lid can be attached to the housing in any number of ways. In one embodiment, a flexible strip is provided between the lid and the housing to connect these sections. In other embodiments, the lid is connected to the housing by a hinge. Preferably, the axis of the hinge lies substantially parallel to the length of the dispensing opening.

In some embodiments, the lid further includes a releasable locking means to releasably lock lid in the closed position. Preferably, the releasable locking means includes at least one element associated with the lid and at least one cooperating element associated with the housing proximate the dispensing opening. In this respect, the releasable locking means can include any suitable cooperating fastener device, cooperative locking arrangement or the like. In one form the releasable locking means includes a cooperating rib and groove type connection. In another form, the releasable locking means includes a projection and a cooperating opening.

In most applications, a user will want to only use a discrete portion of the film from the roll of film. It can therefore be advantageous for the film dispenser to further include a cutting unit on which a layer of film can be cut. The cutting unit can have any suitable configuration, but preferably includes a blade. In some forms, the blade is formed from at least two separate blades arranged to cooperatively cut the film. In other embodiments, the blade includes a single elongate blade. Preferably, the blade is located proximate to the dispensing opening. This allows the film to be cut and removed from the roll of film in or proximate the dispensing opening. This location also allows the film presentation member to be configured to contact and generally adhere thereto a portion of the film between the roll of film and the cutting unit when the lid is in the closed position, or to a part of the housing in which the blade is mounted or extends. In this respect, when the film is cut on the blade, the remaining portion of the film connected to the roll of film generally remains attached to the blade. In this case, the film then conveniently extends between the roll of film and the blade for contact by the film presentation means.

In some forms, the blade is integrally formed with the housing. In other forms, the blade is formed separately, for example as a separate elongate metal blade which is attached the dispenser.

The blade can have any suitable configuration capable of cutting, tearing or otherwise severing the film. In one preferred embodiment, the blade is a saw-toothed blade.

The housing generally has a form suitable for housing a roll of film. In most embodiments the housing therefore takes the form of an elongate box. The elongate box can have a square cross-section, triangular cross-section, generally circular cross-section or the like. The roll of film can be seated loosely in the housing. However, it is preferable for the roll of film to have at least one side retaining means for laterally retaining the roll of film within the housing. In one embodiment, the housing includes at least one moveable side tab for releasably retaining the roll of film within housing. In most cases, the roll of film is mounted on a tubular base roll. Preferably, the moveable side tab is configured to project into the side of the tubular base roll to releasably retaining the roll of film within housing. While one moveable side tab could retain the roll of film within housing, it is preferable for the housing to include two moveable side tabs on opposite sides of the housing. The two moveable side tabs can then cooperatively hold the roll of film within housing.

In one preferable form, the housing and the film presentation member are integrally made from a plastics material. In other forms the housing and the film presentation member are made from different materials.

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of a film dispenser according to one embodiment of the present invention with a lid thereof closed.

FIG. 2 is a perspective view of the film dispenser of FIG. 1 with the lid open.

FIG. 3 is another perspective view of the film dispenser of FIG. 1 with the lid open and the film contained within the film dispenser engaged with a cutter of the film dispenser.

FIG. 4 is a perspective view of the film dispenser of FIG. 1 with the lid open and a roll or film removed from within the film dispenser.

### DETAILED DESCRIPTION

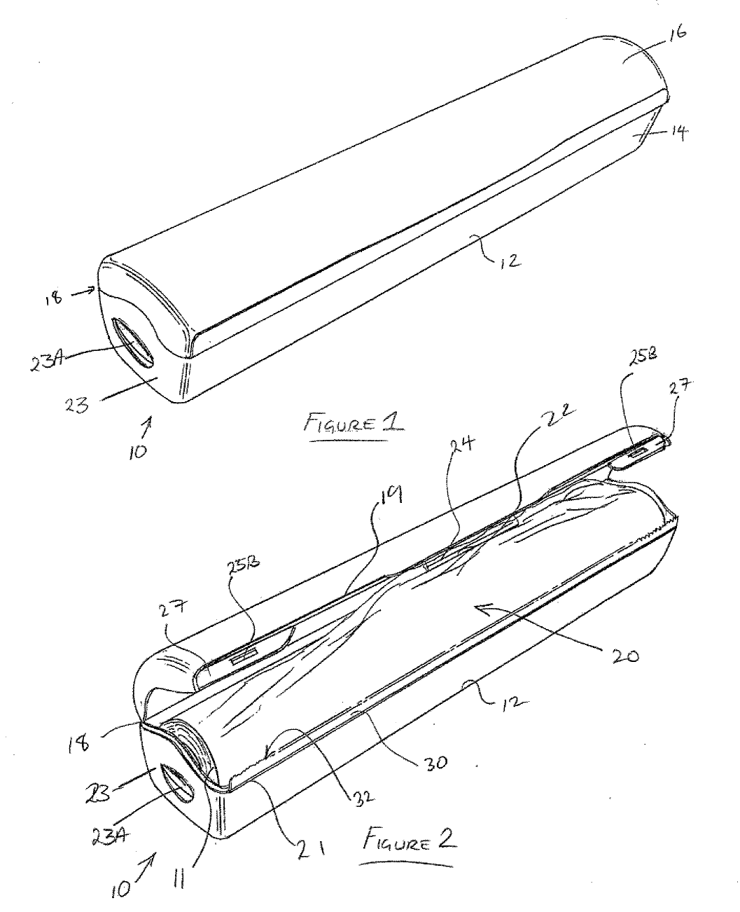

Referring to the accompanying drawings, FIGS. 1 and 2 show a dispenser 10 according to a preferred embodiment of the invention. The dispenser 10 can be configured to dispense portions of various types of film or sheets of material such as cellophane, cling film, foil, grease proof paper, wrapping paper or the like. The illustrated dispenser 10 is configured to dispense a portion of cling film from a tubular roll of cling film 11 housed within the dispenser 10.

The illustrated dispenser 10 is provided with a housing 12. The housing 12 is generally sized and shaped to accommodate the tubular roll of film 11. As shown in FIG. 4, the illustrated roll of film 11 is mounted on a tubular base roll 13. The illustrated housing 12 has a generally square cross-section, but it should be understood that a different shape of housing, for example a housing having a circular or oval cross-section, could also be used. The housing 12 includes a roll retention section 14 and a lid 16 formed as a one-piece unit preferably of a plastics material, for example PVC or other similar plastics material which is safe for food contact. The dispenser 10 can be formed using moulding, extrusion or similar techniques, into the desired shape.

Each side 23 of the roll retention section 14 of the housing 12 includes a moveable side tab 23A for releasably retaining the roll of film 11 within housing 12. In this respect, each side tab 23A is a generally semi-circular shaped tab which is cut out from the sides 23 of the roll retention section 14. The tabs 23A have some movement about a top edge which integrally connects the tab 23 to the side 23. This top edge is formed of a generally rigid material such as PVC (generally the same material so as the majority of the housing 12) to enable the tab to adopt an inwardly projecting position as shown in the figures. The moveable side tab 23A is configured to project into the side of the tubular base roll 13 to releasably retaining the roll of film 11 within housing 12. The two moveable side tabs 23A cooperatively hold the roll of film 11 within the housing 12.

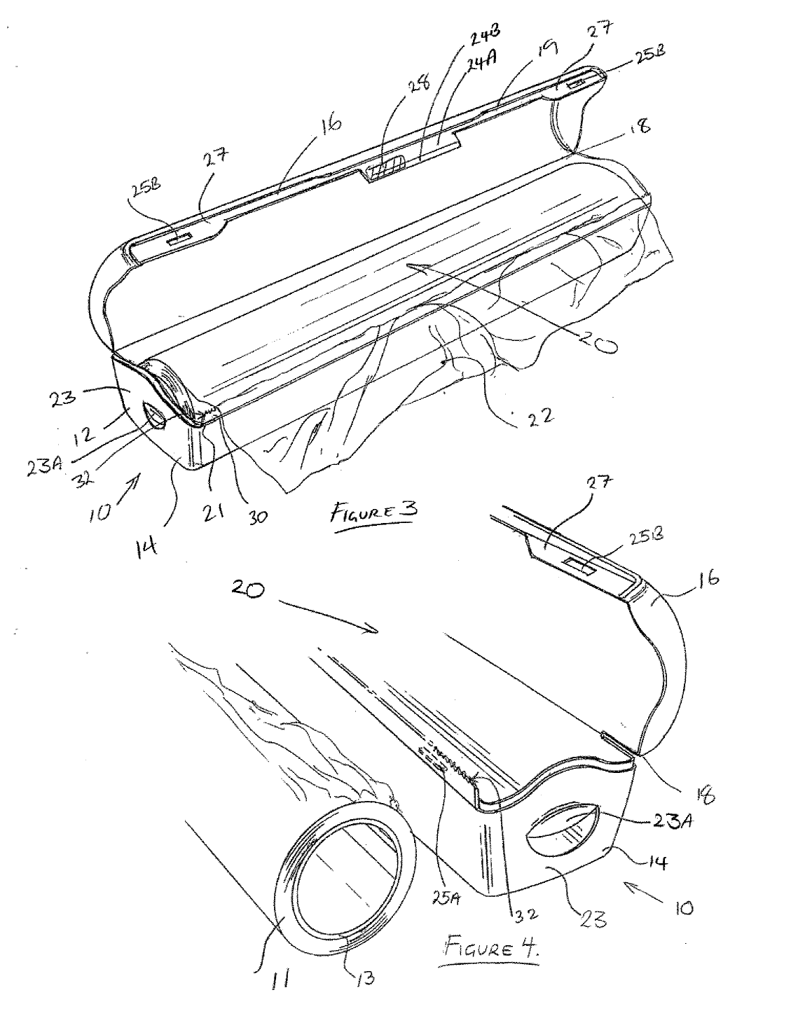

The housing 12 includes a lid 16 which is pivotally connected to the roll retention section 14 through a flexible hinge 18. This hinge 18 can be made of flexible PVC which can be formed with more rigid PVC generally forming the major part of the housing 12. The lid 16 can be moved about the hinge 18 between an open position (as shown in FIGS. 2 and 3) where the front edge 19 of the lid 16 is moved from the front edge 21 of the roll retention section 14 and a closed position (as shown in FIG. 1) where the front edge 19 of the lid 16 generally engages with the front edge 21 of the roll retention section 14.

As best shown in FIG. 4, the roll retention section 14 and the lid 16 further include a releasable locking means in the form of cooperating tabs 25A and openings 25B respectively. The tabs 25A and the openings 25B cooperate proximate the dispensing opening to releasably lock the front edge 19 of the lid 16 to the front edge 21 of the roll retention section 14 when the lid 16 is in the closed position. In the illustrated embodiments, the lid 16 includes two end flanges 27 each having a separate opening 25B. Each opening 25B cooperate with one of two correspondingly positioned inwardly projecting tabs 25A located on an inner surface of the roll retention section 14.

A dispensing opening 20 is formed when the lid 16 is moved to the open position. The dispensing opening 20 is used to pass a section of film 22 from the roll of film 11 outside the housing 12. The dispensing opening 20 is closed when the lid 16 is moved to the closed position. The dispensing opening 20 is wide enough so that at least one layer of the film 11 to be dispensed can be passed through, and is long enough so that the full width of film 11 can also be passed through without wrinkling or folding.

The lid 16 also includes a film presentation member 24 formed as a centrally located (relative to the longitudinal length of the housing 12) downwardly extending tab. The film presentation member 24 is configured to contact and hold, in this case by adhesion, a portion of the film 22 when the lid 16 is in the closed position. The film presentation member 24 is also configured to present said portion of film 22 to a user for grasping when the lid 16 is moved to the open position. In addition, the film presentation member 22 also engages the portion of film 22 within the housing 12 thereby holding that portion of film 22 in place within the dispenser 10 when the lid 16 is moved to the closed position.

The illustrated film presentation member 24 is an integrally formed elongate tab positioned proximate the dispensing opening 20 running generally lengthwise substantially parallel to the dispensing opening 20. As best shown in FIG. 3, the film presentation member 24 is formed from two planar portions, a first planar portion 24A connected to the lid and a second planar portion 24B extending at an angle to the first planar portion 24A in a direction generally away from the dispensing opening 20. When the lid 16 is in the open position, the film presentation member 24 extends away from an inner surface of the lid 16 into the dispensing opening 20 thereby presenting a portion of film at least a small distance away from the lid 16. When in the closed position, the film presentation member 24 is configured to extend at least partially in front of the roll of film 11 to enable film presentation member 24 to contact a piece of film 22 laterally extending between a longitudinal edge of the roll retention section 14 and the roll of film 11 when the lid 16 is moved from the open position to the closed position.

As best shown in FIG. 3, the illustrated film presentation member 24 includes a pressure sensitive adhesive element 28 for releasably adhering the portion of film 22 thereto. The adhesive element 28 includes a section of sticky or other releasably adherable substance to assist in adhering a portion of that film to the presentation member 22.

As shown in FIGS. 2 and 3, the front edge 21 of the roll retention section 14 also includes an elongate blade 30 on which a layer of film can be cut. In the illustrated embodiment, the blade 30 is integrally formed with the housing 12. However, it should be appreciated that the blade 30 can be formed separately in other embodiments, for example as an elongate metal blade which is then attached the dispenser 10.

The illustrated blade 30 is an elongate rib generally running the length of the dispensing opening 20, having an upper saw-toothed shaped cutting edge 32. The blade 30 allows the film to be cut and removed from the roll of film in or proximate the dispensing opening 20. With plastic cling film, the blade 30 is also used to contact and generally adhere thereto a portion of the film 22 between the roll of film 11 and the blade 30 once a section of film is removed from the blade 30 after cutting. In this respect, when the portion film 22 is cut on the blade 30, the remaining portion of the film 22 connected to the roll of film 11 generally remains attached to the blade 30. The film 22 then generally extends between the roll of film 11 and the blade 30.

In use, the dispenser 10 is initially in the closed position, as shown in FIG. 1. A user can then open the lid 16 to open the dispensing opening 20. When initially opened, an end portion of the film from the roll of film 11 is presented to the user on the presentation member 24 within the dispensing opening 20, as shown in FIG. 2. This end portion of the film is adhered to the adhesive element 28 of the presentation member 24. A user can then grasp the end portion of the film using their fingers or similar and detach the end portion of the film from the presentation member 24, draw out a required length of film from the roll of film 11 and detach a section of film 22 of the desired length from the roll of film 11 using the cutting blade 30.

After the portion film 22 is cut on the blade 30, a distal edge portion of the remaining portion of the film 22 connected to the roll of film 11 generally remains attached to the blade 30. The film 22 then generally hangs between the roll of film 11 and the blade 30. The lid 16 can then be closed and locked in place using the cooperating tabs 25A and openings 25B. When the lid 16 is moved to the closed position, the film presentation member 24 is extended at least partially in front of the roll of film 11 to contact and adhere to the piece of film 22 the roll of film 11 and the blade 30. That end portion of the film is thereby attached to the film presentation member 24 ready for presentation within the dispensing opening 20 once the lid 16 is opened once again.

Those skilled in the art will appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1. A film dispenser including a housing configured to receive and hold a roll of film, the housing having a dispensing opening through which a section of film can pass, and a lid movable between an open position where the dispensing opening is open and a closed position in which the dispensing opening is substantially closed,
wherein the lid includes a film presentation member positioned to contact and hold a portion of the film when the lid is in the closed position and to present said portion of film within the dispensing opening for grasping when the lid is moved to the open position.

2. A film dispenser according to claim 1, wherein the film presentation member holds the film by adhesion.

3. A film dispenser according to claim 2, wherein the film presentation member includes an adhesive section for releasably adhering the portion of film thereto.

4. A film dispenser according to claim 3, wherein the adhesive section includes a pressure sensitive adhesive.

5. A film dispenser according to claim 1, wherein the film presentation member is located proximate the dispensing opening.

6. A film dispenser according to claim 1, wherein the film presentation member extends away from the lid into the dispensing opening when the lid is in the open position.

7. A film dispenser according to claim 1, wherein the film presentation member is configured to extend away from an inner surface of the lid and to extend at least partially in front of the roll of film when the lid is in the closed position.

8. A film dispenser according to claim 1, wherein the film presentation member includes at least one a tab projecting away from an inner surface of the lid.

9. A film dispenser according to claim 8, wherein the at least one tab to be an elongate tab running lengthwise substantially parallel a longitudinal edge of the housing that partly defines the dispensing opening.

10. A film dispenser according to claim 9, wherein elongate tab is formed from at least two planar portions, a first planar portion connected to the lid and a second planar portion extending at an angle to the first planar portion in a direction generally away from the dispensing opening.

11. A film dispenser according to claim 1, wherein the lid is connected to the housing by a hinge, the axis of the hinge lying substantially parallel to the length of the dispensing opening.

12. A film dispenser according to claim 1, further including a cutting unit including a blade on which a layer of film can be cut.

13. A film dispenser according to claim 12, wherein the film presentation member is configured to contact and generally adhere thereto a portion of the film between the roll of film and the cutting unit when the lid is in the closed position.

14. A film dispenser according to claim 12, wherein the blade is located proximate to the dispensing opening.

15. A film dispenser according to claim 12, wherein the blade is integrally formed with the housing.

16. A film dispenser according to claim 12, wherein the blade is saw-toothed blade.

17. A film dispenser according to claim 1, wherein the housing includes at least one moveable side tab for releasably retaining the roll of film within housing.

18. A film dispenser according to claim 1, wherein the lid further includes releasable locking means including at least one element associated with the lid and at least one cooperating element associated with the housing proximate the dispensing opening to releasably lock lid in the closed position.

19. A film dispenser according to claim 18, wherein releasable locking means includes a projection and a cooperating opening.
